(19) United States
(12) Patent Application Publication
(10) Pub. No.: US 2026/0273533 A1
(43) Pub. Date: Sep. 17, 2026

(54) LABORATORY DEVICE HAVING A HEATING FUNCTION

(71) Applicant: IKA-Werke GmbH & Co. KG, Staufen (DE)

(72) Inventor: Christian BABEL, Staufen (DE)

(73) Assignee: IKA-Werke GmbH & Co. KG, Staufen (DE)

(21) Appl. No.: 19/479,809

(22) PCT Filed: Apr. 16, 2024
(86) PCT No.: PCT/EP2024/060310

§ 371 Date: Oct. 29, 2025

(30) Foreign Application Priority Data
May 5, 2023 (DE) 102023111755.6

(51) Int. Cl. B01L 7/00; H05B 3/74

(52) U.S. Cl. CPC B01L 7/00; H05B 3/748; B01L 2300/12; B01L 2300/1805

(57) ABSTRACT

A laboratory device (1) having a hotplate structure (3) is provided having: a mounting plate (5) which is made of glass ceramic and on which a heatable mounting surface (4) for at least one vessel is formed; an insulating layer (6); a heating element (7), in particular a heating foil; and a heat conducting layer (8), in particular made of aluminum sheet. The heating element (7) is located between the mounting plate (5) and the insulating layer (6) and the insulating layer (6) is located between the heating element (7) and the heat conducting layer (8).

### CROSS-REFERENCE TO RELATED APPLICATIONS

This application is a 371 National Phase of PCT/EP2024/060310, filed Apr. 16, 2024, which claims priority from German Patent Application No. 10 2023 111 755.6, filed May 5, 2023, both of which are incorporated herein by reference as if fully set forth.

### TECHNICAL FIELD

The invention relates to a laboratory device with a heating function.

### BACKGROUND

Different embodiments of such laboratory devices are already known from practice, for example in the form of magnetic stirrers which have a heatable mounting surface or in the form of laboratory hotplates, and are used to heat media contained in vessels.

The laboratory devices of high heating power that are already known from practice have a relatively high structure, in order to protect the electronics present in the laboratory device against thermal overloading.

Against the background of potential thermal overloading of the electronics in such laboratory devices, up to now more compact laboratory devices with a heating function had to be correspondingly restricted in terms of their heating power.

### SUMMARY

An object of the invention is therefore to provide a laboratory device with a heating function and of the type mentioned in the introduction that can have a compact design in spite of a relatively high heating power.

To achieve this object, a laboratory device having one or more of the means and features disclosed herein that are directed to a laboratory device is proposed. In particular, the proposal for achieving the object therefore involves a laboratory device which has a hotplate structure comprising: a mounting plate, which is made of glass ceramic and on which a heatable mounting surface for at least one vessel is formed; an insulating layer; a heating element, in particular a heating foil; and a heat conducting layer, in particular made of aluminum sheet, wherein the heating element is located between the mounting plate and the insulating layer and the insulating layer is located between the heating element and the heat conducting layer.

In order to prevent the laboratory device from being thermally overloaded by the heating function, it is thus provided that the hotplate structure has: a mounting plate which is made of glass ceramic and on which the mounting surface is formed; an insulating layer; a heating element, in particular a heating foil; and a heat conducting layer, in particular made of aluminum sheet. The heating element is located between the mounting plate and the insulating layer and the insulating layer is located between the heating element and the heat conducting layer.

The heating element, in particular the heating foil, transfers heat not only in the direction of the mounting surface but also in the opposite direction, thus in this case in the direction of a main body of the laboratory device, which can contain temperature-sensitive electronics and/or temperature-sensitive mechanical components. The layer sequence of the hotplate structure prevents excessive heating of the laboratory-device parts located below the hotplate structure.

The insulating layer located below the heating element, in particular below the heating foil, reduces a transfer of heat from the heating element of the hotplate structure to the laboratory-device parts that are on the far side of the insulating layer.

The additional heat conducting layer, which is located below the insulating layer as seen from the heating element, of the hotplate structure allows any heat that passes through the insulating layer to be discharged and thus assists in protecting the magnetic stirrer against thermal overloading.

In one embodiment of the laboratory device, a tolerance compensation layer may also be located between the insulating layer and the heat conducting layer. The tolerance compensation layer allows reliable contact between the insulating layer and the heat conducting layer and can also additionally have an insulating action. The tolerance compensation layer used can for example be a temperature-resistant fiber mat.

For reliable discharge of heat and thus as reliable as possible protection of temperature-sensitive parts of the laboratory device, it can be advantageous if the hotplate structure has a heat conducting profile. The heat conducting profile can be made of a thermally conductive material, for example aluminum. The heat conducting profile can be connected to the heat conducting layer, with the result that heat absorbed by the heat conducting layer can be transferred to the heat conducting profile via the connection to the heat conducting profile. In particular when the heat conducting profile has a large volume and/or a large heat capacity relative to the heat conducting layer, it is possible to also transfer greater amounts of heat to the heat conducting profile and keep that heat away from temperature-sensitive parts of the laboratory device. The heat conducting profile can in this case serve as a heat sink of the hotplate structure.

In one embodiment of the heat conducting profile, it is in the form of a closed profile around the periphery. The heat conducting profile may be in the form of a frame and/or for example have a heat discharging configuration. The heat discharging configuration provided may be for example cooling ribs and/or channels and/or openings and/or bores and/or apertures and/or recesses in the heat conducting profile, which make it possible to enlarge the surface area of the heat conducting profile and thereby improve the capability of the heat conducting profile to discharge heat to the surrounding area. It is also possible for the heat conducting profile to form at least a part of the outer contour of the hotplate structure. In this way, heat fed into the heat conducting profile can be given off to the surrounding area via the outer side of the heat conducting profile. This leads to particularly efficient temperature management and thus particularly efficient protection of the laboratory device equipped with the hotplate structure against thermal overloading. The heat conducting profile may in this case act as a heat exchanger.

In a particularly advantageous embodiment of the laboratory device, it is provided that the mounting plate is adhesively bonded to the heat conducting profile. The mounting plate may be connected to the heat conducting profile for example by a temperature-resistant, preferably double-sided adhesive tape, by a temperature-resistant adhesive and/or by temperature-resistant silicone. In this way, a particularly compact configuration and straightforward production of the hotplate structure are possible. Separate fastening means such as clamps or screws for fixing the mounting plate to the heat conducting profile can thus be omitted.

The heating element of the hotplate structure may be located and/or designed such that only an inner region, on which the mounting surface is formed, of the mounting plate is heated. When a connection is established between the mounting plate and the heat conducting profile by an adhesive connection in a mounting-plate edge region which surrounds the mounting surface in closed form around the periphery of the mounting plate, the adhesive connection between the mounting plate and the heat conducting profile, specifically the preferably double-sided, temperature-resistant adhesive tape, can be protected against thermal overloading.

In a preferred embodiment of the laboratory device, it is provided that a heatable surface of the heating element is spaced apart from the heat conducting profile. This avoids direct contact between the heatable surface and the heat conducting profile. In this way, a direct input of heat into the heat conducting profile can be avoided.

The heatable surface can be surrounded by an unheated edge region of the heating element. The unheatable edge region may consist for example of thermally readily insulating mica material. The unheatable edge region of the heating element makes it possible to at least reduce or at least largely avoid an input of heat into the heat conducting profile directly from the hotplate-structure plane in which the heating element is located. If too much heat is fed into the heat conducting profile in this plane, it can have a negative effect on the efficiency of a function of the heat conducting profile as heat exchanger.

The heatable surface may contain for example heating wires or heating tracks. The heating element may have at least one material-free cutout at the edge. The aim of this is to avoid direct contact between the heating element and the heat conducting profile. The at least one material-free cutout at the edge may adjoin the heatable surface of the heating element.

In one embodiment of the laboratory device, it may be provided that the heating element has support surfaces only in its in particular four corner regions. The support surfaces may consist of mica material. With the support surfaces, the heating element can contact the heat conducting profile in the use position. In that case, the aforementioned material-free cutouts can be formed between the support surfaces of the heating element which are formed in the corner regions. This minimizes a contact surface of the heating element in relation to the heat conducting profile. The four support surfaces formed in the corner regions also promote a centering of the heatable surface of the heating element in the interior of the hotplate structure.

The heat conducting profile may have such a geometry that a projection of the heat conducting profile onto the mounting plate surrounds the mounting surface, formed on the mounting plate, for a vessel in closed fashion.

The insulating layer can consist for example of a microporous insulating material, of polyurethane, of steel wool and/or of glass wool.

As already indicated above, the heat conducting profile may be in the form of a frame. The heat conducting profile may also define an interior space containing the heating element and/or the insulating layer and/or the tolerance compensation layer of the hotplate structure. The heat conducting profile may then serve on the one hand to accommodate the aforementioned layers of the hotplate structure and absorb heat emitted by the heating element and not transferred to the mounting plate. The heat conducting profile may be located between the mounting plate and the heat conducting layer.

The hotplate structure may also have a heat shielding layer, in particular made of high-grade sheet steel. The heat shielding layer may be located on the heat conducting layer. The heat shielding layer may be located in particular on a side of the heat conducting layer facing away from the heating element and/or the heat conducting profile. The heat shielding layer may serve as additional thermal protection for the laboratory device equipped with the hotplate structure against thermal overloading.

The use of the heat shielding layer, in particular made of high-grade steel, is advantageous for example when the heat conducting layer is interrupted at certain points or reduced in terms of its layer thickness. This can be the case in order to minimize a magnetically shielding effect of the heat conducting layer that would adversely affect a magnetic coupling between a stirring point of the laboratory device and a magnetic consumer, such as a stirring magnet. The heat shielding layer in that case serves as a further barrier against heat, which can pass through the heat conducting layer more easily at these points.

In one embodiment of the laboratory device, the hotplate structure has a carrier plate on an underside facing away from the mounting plate. The carrier plate may consist for example of plastic and form a termination of the hotplate structure. Making the carrier plate from plastic can also provide an additional insulating effect and thus contribute to the thermal protection of the laboratory device equipped with the hotplate structure. The carrier plate can be connected, in particular screwed, to the heat conducting profile of the hotplate structure. A screw connection between the carrier plate and the heat conducting profile can press together the individual layers of the hotplate structure and also the aforementioned tolerance compensation layer.

The laboratory device may have at least one light source, for example an LED, in particular an RGB LED, for generating a luminous indicator on the mounting plate. Such an LED then makes it possible to generate a luminous indicator relating to a status indication on the mounting plate, for example adjacent to the mounting surface on the mounting plate.

In one embodiment of the laboratory device, it is provided that a light source is located on the hotplate structure, for example on the aforementioned carrier plate of the hotplate structure. The light source is preferably oriented such that it radiates in the direction of the mounting plate. To generate a luminous indicator on the top side of the mounting plate, the latter may be at least partially transparent or translucent. The mounting plate can then be irradiated from underneath, in order to generate the desired luminous indicator on the top side of the mounting plate.

The hotplate structure may have, for example on the carrier plate, a respective shield against lateral light radiation for each light source. The shield makes it possible to minimize or even completely prevent light from emerging laterally through a gap between the carrier plate and the heat conducting profile. A gap between the carrier plate and the heat conducting profile may be opaquely sealed, in order to avoid light emerging through the gap. The shield(s) may act as reflectors and to this end be provided with a reflective coating, in particular a readily reflective, for example white lacquer. In one embodiment, the laboratory device may have multiple light sources for generating a luminous indicator. These multiple light sources may be for example LEDs, preferably RGB LEDs and/or pixel LEDs, and/or be interconnected via a data bus. The use of pixel LEDs as light sources which can be interconnected via a data bus makes it easier to connect the light sources and further promotes specific activation of the light sources for generating a particularly informative luminous indicator on the mounting plate of the laboratory device. Multiple light sources may be located for example on a printed circuit board.

In particular when the at least one light source is located on the aforementioned carrier plate of the hotplate structure, it can be expedient if the heat conducting profile has at least one light-passage opening, through which light can be conducted from the at least one light source to the and through the preferably at least partially transparent or translucent mounting plate. The heat conducting profile then thermally separates the at least one light source from the heating element of the hotplate structure and at the same time makes it possible to generate the above-described luminous indicator on the mounting plate.

In one embodiment of the laboratory device, it is provided that the heat conducting profile has a plurality of such light-passage openings, preferably surrounding the mounting surface in a ring. In this way, it is possible to generate a luminous indicator surrounding the mounting surface on the mounting plate of the laboratory device in a ring.

The at least one light-passage opening in the heat conducting profile may form a luminous segment of the luminous indicator. The heat conducting profile makes it possible to reliably protect the at least one light source against thermal overloading by the heat given off by the heating element of the hotplate structure. The heat conducting profile thus serves as a spacer between the at least one light source and the heating element and can moreover absorb and discharge heat generated by the at least one light source. The formation of an optically appealing luminous indicator on the mounting plate can be promoted when the mounting plate is at least partially transparent or translucent and/or is free of studs and/or has a ground glass joint and/or a filter and/or a tint at least in the region of the at least one light-passage opening in the heat conducting profile. In particular the use of a ground glass joint, a filter and/or a tint can promote the formation of a uniform and thus especially appealing luminous indicator on the surface of the mounting plate.

A seal may be located between the mounting plate and the heat conducting profile. The seal can prevent moisture from entering. The seal can have at least one light-passage segment which delimits an effective light-exit cross section of the at least one light-passage opening in the heat conducting profile. Thus, the seal can act as an aperture stop, in order to particularly easily give the light segment generated by means of the light-passage opening the desired shape.

The seal may also have a sealing lip which is preferably closed around the periphery and is formed on a seal side facing toward the mounting plate of the hotplate structure in the use position of the seal. The sealing lip may promote the sealing action of the seal. The seal may preferably consist of rubber or silicone.

In one embodiment of the laboratory device, the heat conducting layer of the hotplate structure in at least one region, in particular at least in the region of a stirring point of the laboratory device, may be interrupted and/or filled with a non-magnetically shielding inlay, for example a high-grade steel inlay, and/or reduced in terms of its layer thickness, for example from 2 mm to 0.5 mm or 0.4 mm or 0.3 mm. This makes it possible to minimize or completely avoid a magnetic shielding by the heat conducting layer between the stirring point and a magnetic consumer, for example a stirring magnet.

In one embodiment of the laboratory device, the laboratory device is in the form of a magnetic stirrer with a heating function and with at least one stirring point. In another embodiment of the laboratory device, the laboratory device is in the form of a laboratory hotplate.

### BRIEF DESCRIPTION OF THE DRAWINGS

The invention will be described in more detail below on the basis of an exemplary embodiment but is not restricted to this exemplary embodiment. Further exemplary embodiments emerge by combining the features of individual or several claims with one another and/or by combining individual or several features of the exemplary embodiment.

In the drawing:

FIG. 1 shows a sectional side view of a laboratory device which is in the form of a heatable magnetic stirrer and has a hotplate structure according to the invention,

FIG. 2 shows an exploded representation of the hotplate structure for illustrating the constituent parts and the layer sequence of the hotplate structure of the laboratory device shown in FIG. 1,

FIG. 3 shows a sectional side view of the hotplate structure with the heat conducting profile which is in the form of a frame and is made of aluminum for illustrating light-passage openings, which are formed in the heat conducting profile and allow a luminous indicator to be generated on the top side of the mounting plate of the hotplate structure, and

FIG. 4 shows an isometric representation of the hotplate structure for illustrating the luminous indicator, comprising multiple luminous segments, on the surface of the mounting plate.

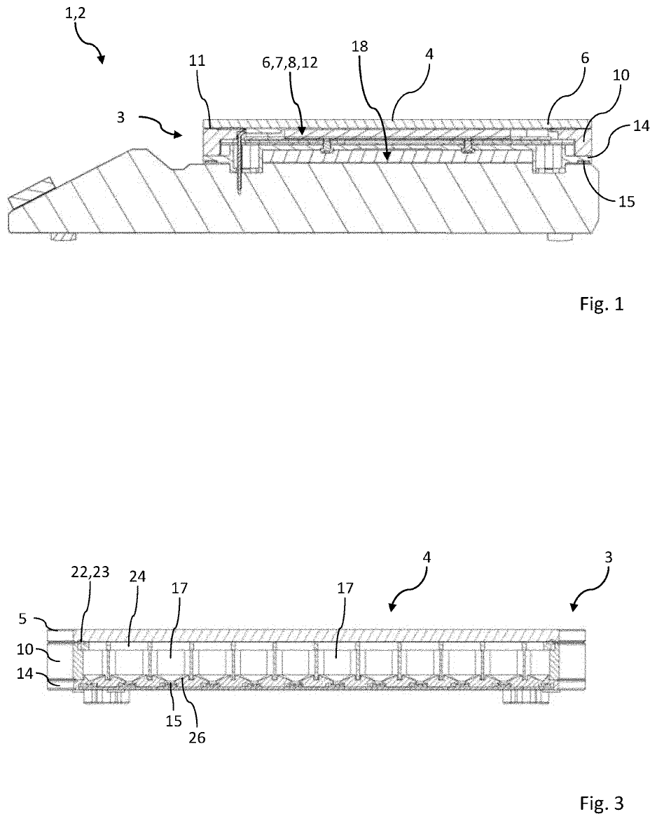

### DETAILED DESCRIPTION

All of the figures show at least parts of a laboratory device which is denoted overall by 1 and is in the form of a magnetic stirrer 2 with a heating function.

To provide the heating function, the laboratory device 1 comprises a hotplate structure 3 which has a heatable mounting surface 4 for at least one vessel.

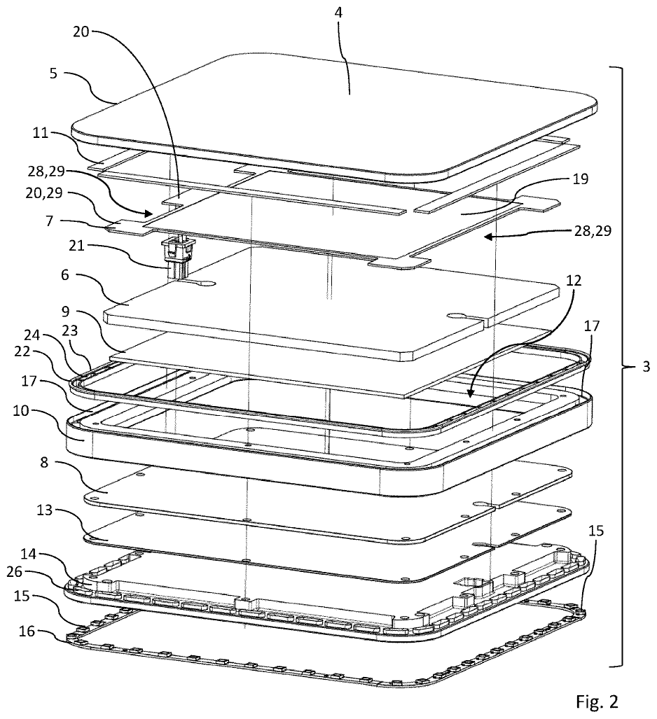

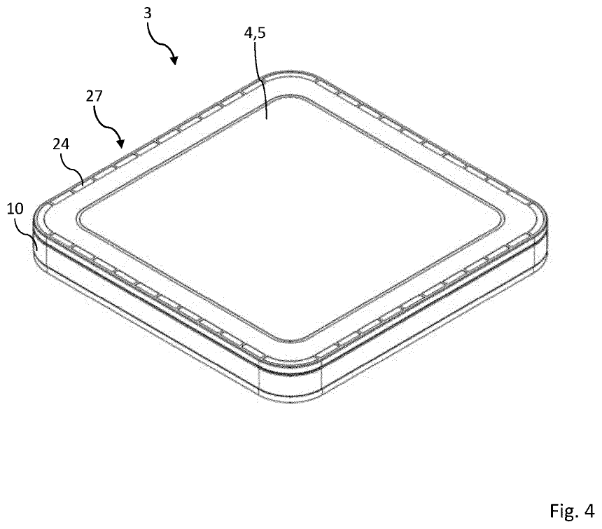

According to FIG. 2, the hotplate structure 3 comprises a mounting plate 5 which is at least partially transparent or translucent at least around the edge, is made of glass ceramic and on which the mounting surface 4 is formed. The hotplate structure 3 also comprises an insulating layer 6, a heating element 7 in the form of a heating foil, and a heat conducting layer 8 made of an aluminum sheet.

The heating element 7 is located below the mounting plate 5 and thus between the mounting plate 5 and the insulating layer 6. The insulating layer 6 is in turn located below the heating element 7 and thus between the heating element 7 and the heat conducting layer 8. Between the insulating layer 6 and the heat conducting layer 8, the hotplate structure 3 comprises a tolerance compensation layer 9 made of a temperature-resistant fiber mat.

The hotplate structure 3 also comprises a heat conducting profile 10 consisting of aluminum and serving as a heat sink. The heat conducting profile 10 is connected to the heat conducting layer 8 such that a transfer of heat from the heat conducting layer 8 to the heat conducting profile 10 is promoted.

FIG. 2 shows that the heat conducting profile 10 is a profile closed around the periphery and in the form of a frame and forms a part of the outer contour of the hotplate structure 3.

According to FIG. 2, the heat conducting profile 10 is located between the mounting plate 5 and the heat conducting layer 8 of the hotplate structure 3. The mounting plate 5 of the hotplate structure 3 is connected, specifically adhesively bonded, to the heat conducting profile 10 by a temperature-resistant, double-sided adhesive tape 11 shown below the mounting plate 5 in FIG. 2. The adhesive tape 11 is located in an edge region of the mounting plate 5 and on an underside of the mounting plate 5. The mounting surface 4 on the mounting plate 5 is located within a projection of the adhesive tape 11 onto the mounting plate 5.

The heating element 7 is located and/or designed such that only an inner region, on which the mounting surface 4 is formed, of the mounting plate 5 is heated. In this way, the adhesive connection between the mounting plate 5 made of glass ceramic and the heat conducting profile 10 made of aluminum is protected against thermal overloading.

The insulating layer 6 of the hotplate structure 3 consists of a microporous insulating material.

The heat conducting profile 10 is, as mentioned above, in the form of a frame. The heat conducting profile 10 comprises an interior space 12 containing the heating element 7, specifically the heating foil, the insulating layer 6 and the tolerance compensation layer 9. The hotplate structure 3 also comprises a heat shielding layer 13 consisting of high-grade sheet steel and located on the heat conducting layer 8. The heat shielding layer 13 is located on an underside, facing away from the heating element 7 and also from the heat conducting profile 10, of the heat conducting layer 8.

On an underside, facing away from the mounting plate 5, of the hotplate structure 3, the latter has a carrier plate 14 made of plastic. The carrier plate 14 thus forms the bottom termination of the hotplate structure 3. The carrier plate 14 can for example be screwed to the heat conducting profile 10.

FIG. 2 shows that the laboratory device 1 has a row of light sources 15 serving to generate a luminous indicator 27 on the mounting plate 5 of the hotplate structure 3 and being located on a printed circuit board in the form of a strip. The luminous indicators 27 make it possible to display for example the status of the laboratory device 1, for example a temperature of the mounting surface 4.

The light sources 15 are RGB LEDs, specifically what are referred to as pixel LEDs, which are located on the hotplate structure 3, specifically on the carrier plate 14 of the hotplate structure 3. The pixel LEDs are interconnected via a data bus 16. This makes it possible to easily connect the light sources 15 and to generate a particularly appealing luminous indicator for displaying the status of the laboratory device 1 on the top side of the at least partially transparent or translucent mounting plate 5.

In order to be able to conduct the light emitted by the light sources 15 for generating the luminous indicator up to and through the mounting plate 5, the heat conducting profile 10 has a row of light-passage openings 17. The light emitted by the light sources 15 can be conducted from below through the light-passage openings 17 to, and ultimately through, the mounting plate 5, which is at least partially transparent or translucent at least in this region. FIG. 2 illustrates that the heat conducting profile 10 has a plurality of such light-passage openings 17 surrounding the mounting surface 4 on the mounting plate 5 in a ring. The light-passage openings 17 can for example conically widen from bottom to top or from top to bottom. Each light-passage opening 17 allows the formation of a luminous segment on the top side of the glass-ceramic mounting plate 5 of the hotplate structure 3.

The mounting plate 5 is at least partially transparent or translucent and is free of studs and/or is provided with a ground glass joint and/or a filter and/or a tint in the region of the light-passage openings 17, in order to promote the formation of individual luminous segments of a luminous indicator to be generated on the top side of the mounting plate 5.

The laboratory device 1 is in the form of a magnetic stirrer 2 and has a stirring point 18.

In order to minimize or completely avoid a magnetic shielding between the stirring point 18 of the laboratory device 1 and a magnetic consumer, for example a stirring magnet, the heat conducting layer 8 in at least one region, specifically in the region of the stirring point 18, may be interrupted and/or filled with a suitable, i.e. non-magnetically shielding inlay, for example a high-grade steel inlay, and/or reduced in terms of its layer thickness, for example from 2 mm to 0.5 mm or 0.4 mm or else 0.3 mm.

The view of the heating element 7 in FIG. 2 illustrates that the heating element 7 has a heatable surface 19 which is located or formed on the heating element 7 such that it is spaced apart from the heat conducting profile 10 in the use position of the heating element 7 on the heat conducting profile 10. In this way, heat generated by the heatable surface 19 of the heating element 7 is prevented from being given off directly onto the heat conducting profile 10.

FIG. 2 also illustrates that the heatable surface 19 of the heating element 7 is surrounded by an unheated edge region 20 of the heating element 7. This edge region 20 may consist of a mica material, which has good thermally insulating properties and thus counteracts a direct discharge of heat onto the heat conducting profile 10. In the unheated edge region 20 of the heating element 7, the heating element 7 also has material-free cutouts 28 at the edge. The material-free cutouts 28 adjoin the heatable surface 19 of the heating element 7. Providing material-free cutouts 28 in the edge region 20 of the heating element 7 has the advantage that contact between the heating element 7 and the heat conducting profile 10 in these regions can be reduced or even completely avoided. Accordingly, a transfer of heat from the heatable surface 19 of the heating element 7 to the heat conducting profile 10 at this point is also minimized or even completely avoided.

The heating element 7 can be supplied with current via a current terminal 21.

The figures also illustrate that a seal 22 is located between the mounting plate 5 and the heat conducting profile 10. The seal 22 has a sealing lip 23 around the periphery, facing toward the mounting plate 5, and prevents moisture from entering between the mounting plate 5 and the heat conducting profile 10.

The seal 22 is provided with a row of light-passage segments 24. The light-passage segments 24 serve to define and shape an effective light-emergence cross section of the light-passage openings 17 in the heat conducting profile 10. In this way, it is possible to create the light-passage openings 17 in the heat conducting profile 10 for example by means of a milling cutter. The use of a milling cutter gives the light-passage openings 17 inside the heat conducting profile 10 a determined, specifically rounded shape. If it is desired to create luminous segments 25 with a polygonal or rectangular shape on the mounting plate 5, this can be done particularly easily by means of the correspondingly shaped light-passage segments 24 within the seal 22.

The seal 22 with its light-passage segments 24 thus serves as a shaping aperture stop which ultimately predefines the shape of the luminous segments 25 on the mounting plate 5 of the laboratory device 1.

In order to avoid light emerging laterally from a contact plane between the carrier plate 14 and the heat conducting profile 10, the hotplate structure 3 has a respective shield 26 on the carrier plate 14 for each light source 15. The shields 26 reach to some extent into the light-passage openings 17 in the heat conducting profile 10 and prevent the light sources 15 located inside the shields 26 from emitting their light laterally through any gap present between the carrier plate 14 and the heat conducting profile 10, this possibly disrupting the appearance of the laboratory device 1.

The shields 26 may have a reflective coating, for example in the form of a white lacquer, and are configured such that they correspond to radiation angles of the light sources 15 and thus do not adversely affect light radiation upward. This promotes the formation of robust light segments 25 as luminous indicator 27 on the top side of the mounting plate 5.

### LIST OF REFERENCE SIGNS

1 Laboratory device
2 Magnetic stirrer
3 Hotplate structure
4 Mounting surface
5 Mounting plate
6 Insulating layer
7 Heating element
8 Heat conducting layer
9 Tolerance compensation layer
10 Heat conducting profile
11 Adhesive tape
12 Interior space of 10
13 Heat shielding layer
14 Carrier plate
15 Light source
16 Data bus
17 Light-passage opening
18 Stirring point on 1
19 Heatable surface of 7
20 Unheatable edge region of 7
21 Current terminal for 7
22 Seal
23 Sealing lip on 22
24 Light-passage segment in 22
25 Luminous segment
26 Shield on 14 for 15
27 Luminous indicator
28 Cutout in 20
29 Support surface

1. A laboratory device (1) with a heating function, the laboratory device (1) comprising:
a hotplate structure (3) including:
a mounting plate (5) which is made of glass ceramic and on which a heatable mounting surface (4) for at least one vessel is formed;
an insulating layer (6);
a heating element (7); and
a heat conducting layer (8),
wherein the heating element (7) is located between the mounting plate (5) and the insulating layer (6) and the insulating layer (6) is located between the heating element (7) and the heat conducting layer (8).

2. The laboratory device (1) as claimed in claim 1, wherein the hotplate structure (3) has a tolerance compensation layer (9) between the insulating layer (6) and the heat conducting layer (8).

3. The laboratory device (1) as claimed in claim 2, wherein the hotplate structure (3) has a heat conducting profile (10) which is connected to the heat conducting layer (8).

4. The laboratory device (1) as claimed in claim 3, wherein the heat conducting profile (10) at least one of: a) is a closed profile around a periphery, b) has a heat discharging configuration, c) forms at least a part of an outer contour of the hotplate structure (3), or d) is located between the mounting plate (5) and the heat conducting layer (8).

5. The laboratory device (1) as claimed in claim 3, wherein the mounting plate (5) is adhesively bonded to the heat conducting profile (10).

6. The laboratory device (1) as claimed in claim 1, wherein the heating element (7) is at least one of located or designed such that only an inner region of the mounting plate (5), on which the mounting surface (4) is formed, is heatable.

7. The laboratory device (1) as claimed in claim 3, wherein a heatable surface (19) of the heating element (7) is spaced apart from the heat conducting profile (10) and/or is surrounded by an unheated edge region (20) of the heating element (7) and/or the heating element (7) has at least one material-free cutout (28), which is at an edge and adjoins a heatable surface (19) of the heating element (7), and/or in corner regions thereof has a respective support surface (29), with which the heating element (7) contacts the heat conducting profile (10) in a use position.

8. The laboratory device (1) as claimed in claim 1, wherein the insulating layer (6) is made of a microporous insulating material, of polyurethane, of steel wool and/or of glass wool.

9. The laboratory device (1) as claimed in claim 3, wherein the heat conducting profile (10) at least one of a) is located between the mounting plate (5) and the heat conducting layer (8), b) is formed as a frame, or c) defines an interior space (12) containing at least one of the heating element (7), the insulating layer (6), or the tolerance compensation layer (9).

10. The laboratory device (1) as claimed in claim 3, wherein the hotplate structure (3) has a heat shielding layer (13) which is located on the heat conducting layer (8), on a side of the heat conducting layer (8) facing away from the heating element (7) and/or the heat conducting profile (10).

11. The laboratory device (1) as claimed in claim 1, wherein the hotplate structure (3) has a carrier plate (14) on an underside facing away from the mounting plate (5).

12. The laboratory device (1) as claimed in claim 1, further comprising at least one light source (15) for generating a luminous display on the mounting plate (5).

13. The laboratory device (1) as claimed in claim 12, wherein the at least one light source (15) is located on the hotplate structure (3), and the hotplate structure (3) has a respective, shield (26) against lateral light radiation for each of the at least one light source (15).

14. The laboratory device (1) as claimed in claim 12, wherein the at least one light source comprises multiple light sources (15) formed as LEDs, interconnected via a data bus (16), for generating the luminous display.

15. The laboratory device (1) as claimed in claim 3, further comprising at least one light source (15) for generating a luminous display on the mounting plate (5), and the heat conducting profile (10) has at least one light-passage opening (17), through which light from the at least one light source (15) is adapted to be conducted to and through the mounting plate (5).

16. The laboratory device (1) as claimed in claim 16, wherein the mounting plate (5) is at least one of: a) partially transparent or translucent, b) free of studs, or c) has at least one of a ground glass joint, a filter, or a tint at least in a region of the at least one light-passage opening (17).

17. The laboratory device (1) as claimed in claim 16, wherein a seal (22) is located between the mounting plate (5) and the heat conducting profile (10), the seal (22) has a sealing lip (23) facing toward the mounting plate (5) and/or has at least one light-passage segment (24) defining an effective light-emergence cross section of the at least one light-passage opening (17) of the heat conducting profile (10).

18. The laboratory device (1) as claimed in claim 1, wherein the heat conducting layer (8) in at least one region is interrupted and/or filled with a magnetic inlay, and/or reduced in terms of a layer thickness in order to minimize or completely avoid a magnetic shielding between the stirring point (18) and a magnetic consumer.

19. The laboratory device (1) as claimed in claim 1, wherein the laboratory device (1) is formed as a laboratory hotplate or a magnetic stirrer (2) with a heating function and with at least one stirring point (18).
